(19) United States
(12) Patent Application Publication
(10) Pub. No.: US 2020/0281134 A1
(43) Pub. Date: Sep. 10, 2020

(54) GROWTH SUBSTRATE PRODUCT

(71) Applicant: ROCKWOOL International A/S, Hedehusene (DK)

(72) Inventors: Thomas HJELMGAARD, Fredensborg (DK); Frank Hendrikus Peter JANSSEN, Helden (NL)

(21) Appl. No.: 16/067,145

(22) PCT Filed: Dec. 21, 2016
(86) PCT No.: PCT/EP2016/082220

§ 371 Date: Jun. 29, 2018

(30) Foreign Application Priority Data
Dec. 29, 2015 (EP) 15202899.9

(51) Int. Cl. A01G 24/35; A01G 24/40; A01G 24/10; A01G 24/22

(52) U.S. Cl. CPC A01G 24/35; A01G 24/22; A01G 24/10; A01G 24/40

(57) ABSTRACT

A coherent growth substrate product formed of man-made vitreous fibres (MMVF) bonded with a cured binder composition and a wetting agent is described, wherein the binder composition prior to curing comprises the following components: a component (i) in the form of one or more compounds selected from compounds of the formula (I), and any salts thereof: in which R1 corresponds to H, alkyl, monohydroxyalkyl, dihydroxyalkyl, polyhydroxyalkyl, alkylene, alkoxy, amine; compounds of the formula (II), and any salts thereof: in which R2 corresponds to H, alkyl, monohydroxyalkyl, dihydroxyalkyl, polyhydroxyalkyl, alkylene, alkoxy, amine; a component (ii) in the form of one or more compounds selected from the group of ammonia, amines or any salts thereof; a component (iii) in the form of one or more carbohydrates. Use of said coherent growth substrate product for growing plants and propagating seeds is also disclosed. In addition, a process for making said coherent growth substrate product is disclosed.

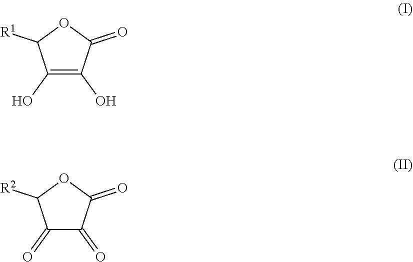

The invention relates to a coherent growth substrate product, use of a coherent growth substrate product as a substrate for growing plants, or for propagating seeds, a method of growing plants in a coherent growth substrate, a method of propagating seeds in a coherent growth substrate product, and a process for making a coherent growth substrate product.

It has been known for many years to grow plants in coherent growth substrates formed from man-made vitreous fibres (MMVF). MMVF products for this purpose, which are provided as a coherent plug, block or slab, generally include a binder, usually an organic binder, in order to provide structural integrity to the product. This allows the growth substrate product to retain its structure during water irrigation. However, MMVF products which are to be used as growth substrates must have a capacity to take up and hold water, which is routinely supplied by an irrigation system to the growth substrate product, and must also have re-wetting properties. Accordingly, it has been well known for some years to include a wetting agent in MMVF products which are to be used as growth substrates.

The combination of binder and wetting agent is of the highest importance in commercial growing of plants in MMVF growth substrates, as these components determine certain chemical and physical properties of the growth substrates. For example, the binder and wetting agent can affect water retention properties, re-saturation properties (ability of the growth substrate to take up water a second time once it has been wetted and then dried), initial wetting, water distribution properties (ability of the growth substrate to hold water at a more uniform concentration throughout the height, the length and the width of the growth substrate rather than concentrating at the base), phytotoxicity and mechanical properties of the MMVF plant growth substrate.

One early example of a mineral wool product which can be used as a growth substrate is given by GB-A-1336426, which describes readily wettable mineral wool products suitable for use as growth substrates. To provide structure and shape, the fibres contain a binder such as a phenol formaldehyde resin, or urea formaldehyde resin. To provide the required water-holding characteristics the product also contains a wetting agent. General classes of wetting agents are mentioned, such as anionic, cationic and non-ionic wetting agents.

EP-A-1226749 discloses a process for the production of water-absorbing mineral fibre products, which can be used for growing plants, the products comprising binder, wetting agent and aliphatic polyol. The binder can be a conventional phenol-based resin and the wetting agent can be selected from a long list including salts of higher fatty acids, alkyl or aralkyl sulphates or sulphonates, fatty alcohol sulphates, alkyl phosphates, fatty alcohol ethoxylates, alkyl phenol ethoxylates, fatty amine ethoxylates, fatty acid ethoxylates, alkyl ammonium compounds.

Further examples of documents which disclose the use of formaldehyde-containing binders include WO2009/090053, WO2008009467, WO2008/009462, WO2008/009461, WO2008/009460 and WO2008/009465. In these examples, the binder is phenol formaldehyde resin and the wetting agents are ionic surfactants.

EP1278410 discloses the use of a non-ionic fatty acid polyglycol ester surfactant as a wetting agent, such as Rewopal E070, in a growth substrate product which is preferably bonded with a formaldehyde resin binder.

Formaldehyde binders have found widespread use because they can be economically produced. However, the use of formaldehyde-containing binders is known to have negative effects in terms of phytotoxicity. Therefore, attempting to improve the mechanical properties of MMVF growth substrates by increasing the amount of formaldehyde-containing binder can have a negative impact on plant growth and development, as plants are sensitive to formaldehyde concentrations. Furthermore, there have been suggestions that formaldehyde compounds can be damaging to health and are therefore environmentally undesirable; this has been reflected in legislation directed to lowering or eliminating formaldehyde emissions.

Other types of binder than the standard phenol urea formaldehyde type have been disclosed for use in mineral wool growth substrates

One such example is disclosed in WO2012/028650. A mineral fibre product comprising MMVF bonded with a cured binder composition is disclosed, wherein the binder composition prior to curing comprises (i) a sugar component, (ii) a reaction product of a polycarboxylic acid component and an alkanolamine component and (iii) a wetting agent. Preferably the wetting agent is an anionic surfactant, comprising a linear alkyl benzene sulphonate (LAS). Although the water handling properties of the system are good, they show room for improvement. In addition, the phytotoxicity properties of the binder disclosed in WO2012/028650 could be improved. Further, the binder composition of WO2012/028650 requires relatively high temperatures for curing; therefore it would be desirable to produce a binder composition with a reduced curing temperature.

One further example is WO2015/181323 which discloses use of alkyl ether sulphates as a wetting agent in MMVF growth substrates. This document discloses bonding the MMVF substrate with one of various binders, including formaldehyde resins and sugar-containing resins.

Although not in the field of plant growth substrates, WO2007/014236 discloses various formaldehyde-free binders to be used in the fabrication of materials such as fibreglass.

Disadvantages associated with known formaldehyde-free binders include the fact that the starting materials are often relatively expensive and derived from fossil fuels.

Whilst such systems described above are effective generally, there is room for improvement in the growth substrate product in various respects. Specifically, there is a need for an improved binder and wetting agent system for MMVF plant growth substrates.

It would be desirable to provide a binder and wetting agent system which is not deemed environmentally undesirable, and which has low phytotoxicity. It would be desirable to provide systems which show improved re-saturation properties; improved water distribution properties; improved water retention and improved initial wetting. It would be desirable to provide systems which show improved seed germination, rooting-in and plant growth with a higher proportion of plants in the required selection category and with the highest uniformity between the plants. It would be desirable to provide a system which imparts the above advantages but which maintains the mechanical properties of known MMVF substrates. It would be desirable to provide a binder and wetting agent system which shows these advantages over known systems, but which has comparable convenience and economy in terms of production, and which is at least partly derived from renewable materials.

### SUMMARY OF INVENTION

In a first aspect, there is provided a coherent growth substrate product formed of man-made vitreous fibres (MMVF) bonded with a cured binder composition and a wetting agent, wherein the binder composition prior to curing comprises the following components:

a component (i) in the form of one or more compounds selected from
compounds of the formula, and any salts thereof:

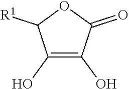

in which R1 corresponds to H, alkyl, monohydroxyalkyl, dihydroxyalkyl, polyhydroxyalkyl, alkylene, alkoxy, amine;
compounds of the formula, and any salts thereof:

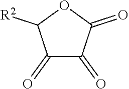

in which R2 corresponds to H, alkyl, monohydroxyalkyl, dihydroxyalkyl, polyhydroxyalkyl, alkylene, alkoxy, amine;

a component (ii) in the form of one or more compounds selected from the group of ammonia, amines or any salts thereof;

a component (iii) in the form of one or more carbohydrates.

In a second aspect of the present invention there is provided use of a growth substrate product according to the first aspect of the invention as a growth substrate for growing plants or for propagating seeds.

In a third aspect of the present invention there is provided a method of growing plants in a coherent growth substrate product, the method comprising:

providing at least one growth substrate product formed of man-made vitreous fibres bonded with a cured binder composition and a wetting agent; positioning one or more plants for growth in the growth substrate product; and

irrigating the growth substrate product;

characterised in that the binder composition prior to curing comprises the following components:

a component (i) in the form of one or more compounds selected from;
compounds of the formula, and any salts thereof:

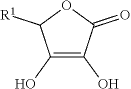

in which R1 corresponds to H, alkyl, monohydroxyalkyl, dihydroxyalkyl, polyhydroxyalkyl, alkylene, alkoxy, amine;
compounds of the formula, and any salts thereof:

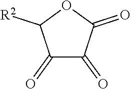

in which R2 corresponds to H, alkyl, monohydroxyalkyl, dihydroxyalkyl, polyhydroxyalkyl, alkylene, alkoxy, amine;

a component (ii) in the form of one or more compounds selected from the group of ammonia, amines or any salts thereof;

a component (iii) in the form of one or more carbohydrates.

In a fourth aspect of the present invention there is provided a method of propagating seeds in a coherent growth substrate product, the method comprising:

providing at least one growth substrate product formed of man-made vitreous fibres bonded with a cured binder composition and a wetting agent,

positioning one or more seeds in the growth substrate product,

irrigating the growth substrate product; and

allowing germination and growth of the seed to form a seedling;

characterised in that the binder composition prior to curing comprises the following components:

a component (i) in the form of one or more compounds selected from

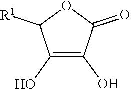

compounds of the formula, and any salts thereof:

in which R1 corresponds to H, alkyl, monohydroxyalkyl, dihydroxyalkyl, polyhydroxyalkyl, alkylene, alkoxy, amine;
compounds of the formula, and any salts thereof:

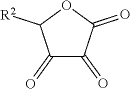

in which R2 corresponds to H, alkyl, monohydroxyalkyl, dihydroxyalkyl, polyhydroxyalkyl, alkylene, alkoxy, amine;

a component (ii) in the form of one or more compounds selected from the group of ammonia, amines or any salts thereof;

a component (iii) in the form of one or more carbohydrates.

In a fifth aspect of the present invention there is provided a process of making a coherent growth substrate product comprising the steps of:
(i) providing man-made vitreous fibres;
(ii) spraying the man-made vitreous fibres with a binder composition;
(iii) spraying the man-made vitreous fibres with a wetting agent;
(iv) collecting and consolidating the man-made vitreous fibres; and
(v) curing the binder composition;

characterised in that the binder composition prior to curing comprises the following components:

a component (i) in the form of one or more compounds selected from
compounds of the formula, and any salts thereof:

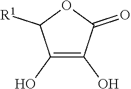

in which R1 corresponds to H, alkyl, monohydroxyalkyl, dihydroxyalkyl, polyhydroxyalkyl, alkylene, alkoxy, amine;
compounds of the formula, and any salts thereof:

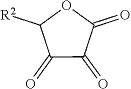

in which R2 corresponds to H, alkyl, monohydroxyalkyl, dihydroxyalkyl, polyhydroxyalkyl, alkylene, alkoxy, amine;

a component (ii) in the form of one or more compounds selected from the group of ammonia, amines or any salts thereof;

a component (iii) in the form of one or more carbohydrates.

### DETAILED DESCRIPTION OF INVENTION

### Growth Substrate Product

The growth substrate product of the invention is formed of man-made vitreous fibres (MMVF). The MMVF can be of the conventional type used for formation of known MMVF growth substrates. It can be glass wool or slag wool but is usually stone wool. Stone wool generally has a content of iron oxide at least 3% and content of alkaline earth metals (calcium oxide and magnesium oxide) from 10 to 40%, along with the other usual oxide constituents of mineral wool. These are silica; alumina; alkali metals (sodium oxide and potassium oxide) which are usually present in low amounts; and can also include titania and other minor oxides. In general it can be any of the types of man-made vitreous fibre which are conventionally known for production of growth substrates.

Fibre diameter is often in the range of 2 to 10 microns, in particular 3 to 8 microns, as conventional.

Preferably the growth substrate product comprises at least 90 wt % man-made vitreous fibres by weight of the total solids content of the growth substrate. An advantage of having such an amount of fibres present in the growth substrate product is that there are sufficient pores formed between the fibres to allow the growth substrate product to hold water and nutrients for the plant, whilst maintaining the ability for roots of the plants to permeate the growth substrate product. The remaining solid content is made up primarily of binder and wetting agent.

The MMVF may be made by any of the methods known to those skilled in the art for production of MMVF growth substrate products. In general, a mineral charge is provided, which is melted in a furnace to form a mineral melt. The melt is then formed into fibres by means of rotational fiberisation such as internal centrifugal fiberisation e.g. using a spinning cup, or external centrifuging e.g. using a cascade spinner, to form a cloud of fibres. These fibres are then collected and consolidated. Binder and wetting agent are usually added at the fiberisation stage by spraying into the cloud of forming fibres. These methods are well known in the art.

Preferably the growth substrate product has an average density of from 30 to 150 kg/m³, such as 30 to 100 kg/m³, more preferably 40 to 90 kg/m³.

The growth substrate product preferably has a volume in the range 3 to 86400 cm³, such as 5 to 30,000 cm³, preferably 8 to 20,000 cm³. The growth substrate product may be in the form of a product conventionally known as a plug, or in the form of a product conventionally known as a block, or in the form of a product conventionally known as a slab.

The growth substrate product may have dimensions conventional for the product type commonly known as a plug. Thus it may have height from 20 to 35 mm, often 25 to 28 mm, and length and width in the range 15 to 25 mm, often around 20 mm. In this case the substrate is often substantially cylindrical with the end surfaces of the cylinder forming the top and bottom surfaces of the growth substrate.

The volume of the growth substrate product in the form of a plug is preferably not more than 150 cm³. In general the volume of the growth substrate product in the form of a plug is in the range 0.6 to 40 cm³, preferably 3 to 150 cm³ and preferably not more than 100 cm³, more preferably not more than 80 cm³, in particular not more than 75 cm³, most preferably not more than 70 cm³. The minimum distance between the top and bottom surfaces of a plug is preferably less than 60 mm, more preferably less than 50 mm and in particular less than 40 mm or less.

Another embodiment of a plug has height from 30 to 50 mm, often around 40 mm and length and width in the range 20 to 40 mm, often around 30 mm. The growth substrate in this case is often of cuboid form. In this first case the volume of the growth substrate is often not more than 50 cm³, preferably not more than 40 cm³.

Alternatively the growth substrate may be of the type of plug described as the first coherent MMVF growth substrate in our publication WO2010/003677. In this case the volume of the growth substrate product is most preferably in the range to 10 to 40 cm³.

The growth substrate product may have dimensions conventional for the product type commonly known as a block. Thus it may have height from 5 to 20 cm, often 6 to 15 cm, and length and width in the range 4 to 30 cm, often 10 to 20 cm. In this case the substrate is often substantially cuboidal. The volume of the growth substrate product in the form of a block is preferably in the range 80 to 8000 cm³, preferably 50 cm³ to 5000 cm³, more preferably 100 cm³ to 350 cm³, most preferably 250 cm³ to 2500 cm³.

The growth substrate product may have dimensions conventional for the product type commonly known as a slab. Thus it may have height from 5 to 15 cm, often 7.5 to 12.5 cm, a width in the range of 5 to 30 cm, often 12 to 24 cm, and a length in the range 30 to 240 cm, often 40 to 200 cm. In this case the substrate is often substantially cuboidal. The volume of the growth substrate product in the form of a slab is preferably in the range 750 to 86,400 cm³, preferably 3 litres to 20 litres, more preferably 4 litres to 15 litres, most preferably 6 litres to 15 litres.

The height is the vertical height of the growth substrate product when positioned as intended to be used and is thus the distance between the top surface and the bottom surface. The top surface is the surface that faces upwardly when the product is positioned as intended to be used and the bottom surface is the surface that faces downwardly (and on which the product rests) when the product is positioned as intended to be used.

In general, the growth substrate product may be of any appropriate shape including cylindrical, cuboidal and cubic. Usually the top and bottom surfaces are substantially planar.

The growth substrate product is in the form of a coherent mass. That is, the growth substrate is generally a coherent matrix of man-made vitreous fibres, which has been produced as such, but can also be formed by granulating a slab of mineral wool and consolidating the granulated material.

### Binder Composition

The present inventors have found that it is possible to prepare a binder composition for coherent MMVF growth substrates that uses, to a large extent, starting materials which are renewable and at the same time allow the economical production of the binder. Since a significant part of the starting materials used for the binder according to the present invention stems from biomass and at the same time the materials used are comparatively low in price, the binder according to the present invention is both economically and ecologically advantageous. The combination of these two aspects is particularly remarkable, since “biomaterials” are often more expensive than conventional materials.

A further advantage of the present invention is that the binder composition for use in coherent MMVF growth substrates can be formaldehyde-free. Formaldehyde is commonly used as a binder for MMVF plant growth substrates, as it is relatively inexpensive and results in a product with good mechanical strength. However, plants are sensitive to the concentration of formaldehyde, which can effect plant growth and development. Further, there has been recent legislation which seeks to reduce or eliminate formaldehyde emissions, as they are seen as environmentally undesirable. The binder composition of the present invention is formaldehyde-free and has low phytotoxicity. Therefore, it is possible to increase the amount of binder used to higher concentrations, if necessary, in order to improve the mechanical properties of the MMVF growth substrate product, without significantly impacting plant growth and development.

At the same time, the binders according to the present invention show excellent properties when used for binding MMVF growth substrate products. The binder composition has mechanical properties comparable to known binders, but has the advantage of being economical to produce, and can be synthesised largely from renewable materials. An additional advantage of the binders according to the present invention is that they have a comparatively high curing speed at a low curing temperature. Further, the binders according to one embodiment of the present invention are not strongly acidic and therefore overcome corrosion problems associated with strongly acidic binders known from the prior art.

Further, when the binder composition is used in combination with a wetting agent, excellent water-handling properties are seen. For example, the present invention shows improved re-saturation properties; improved water distribution properties; improved water retention and improved initial wetting. This ultimately leads to the growth of stronger and healthier plants.

Furthermore, when the binder composition is used in combination with a wetting agent, improved seed germination, rooting-in and plant growth with a higher proportion of plants in the required selection category and with the highest uniformity between the plants is seen.

The binder composition for use in the present invention will now be described in more detail.

The binder composition prior to curing comprises the following components:

a component (i) in the form of one or more compounds selected from
compounds of the formula, and any salts thereof:

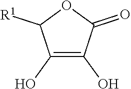

in which R1 corresponds to H, alkyl, monohydroxyalkyl, dihydroxyalkyl, polyhydroxyalkyl, alkylene, alkoxy, amine;
compounds of the formula, and any salts thereof:

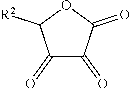

in which R2 corresponds to H, alkyl, monohydroxyalkyl, dihydroxyalkyl, polyhydroxyalkyl, alkylene, alkoxy, amine;

a component (ii) in the form of one or more compounds selected from the group of ammonia, amines or any salts thereof;

a component (iii) in the form of one or more carbohydrates.

Preferably the binder composition is an aqueous binder composition. This allows for improved binder mixing, improved binder distribution throughout the MMVF growth substrate, and also means that a lower binder content is required. Preferably the binders have a pH of 6-9. Preferably the binders are formaldehyde-free. For the purpose of the present application, the term “formaldehyde free” is defined to characterise a mineral wool product where the emission is below 5 μg/m²/h of formaldehyde from the mineral wool product, preferably below 3 μg/m²/h. Preferably the test is carried out in accordance with ISO 16000 for testing aldehyde emissions.

Preferably, alkyl is C₁-C₁₀ alkyl. Preferably, monohydroxyalkyl is monohydroxy C₁-C₁₀ alkyl. Preferably, dihydroxyalkyl is dihydroxy C₁-C₁₀ alkyl. Preferably, polyhydroxyalkyl is polyhydroxy C₁-C₁₀ alkyl. Preferably, alkylene is alkylene C₁-C₁₀ alkyl. Preferably, alkoxy is alkoxy C₁-C₁₀ alkyl.

### Component (i) of the Binder composition

Preferably, component (i) is in the form of one or more components selected from ascorbic acid or isomers or salts or derivatives, preferably oxidized derivatives, thereof.

We have found that ascorbic acid, which is a comparatively low-price material and can be produced from biomass, or its derivatives, can be used as a basis for a binder composition for use in MMVF plant growth substrates.

Ascorbic acid, or vitamin C, is a non-toxic, naturally-occurring organic compound with antioxidant properties. Industrially, ascorbic acid can for example be obtained by fermentation of glucose. The core structure of ascorbic acid contains a unique five-membered ring, a γ-lactone, containing an enediol. Ascorbic acid can thus be classified as a 3,4-dihydroxy-furan-2-one. This has particular advantages when used as a binder for plant growth substrates, due to low phytotoxicity of this compound.

Even though ascorbic acid does not contain a carboxylic acid functionality, the 3-hydroxy group is reasonably acidic (pKa=4.04) since the resulting ascorbate anion is stabilized by charge delocalization.

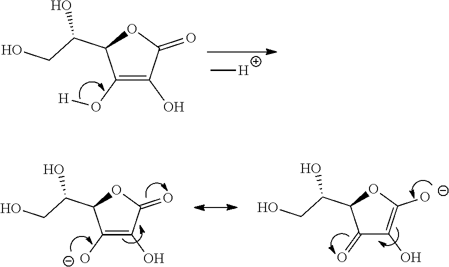

In a preferred embodiment, component (i) is selected from L-ascorbic acid, D-iso-ascorbic acid, 5,6-isopropylidene ascorbic acid, dehydroascorbic acid and/or any salt of the compounds, preferably calcium, sodium, potassium, magnesium or iron salts.

In a further preferred embodiment, component (i) is selected from L-ascorbic acid, D-isoascorbic acid, 5,6-isopropylidene ascorbic acid and dehydroascorbic acid.

### Component (ii) of the Binder Composition

Component (ii) is selected from ammonia, amines or any salts thereof. In a preferred embodiment, component (ii) is selected from ammonia, piperazine, hexadimethylenediamine, m-xylylenediamine, diethylenetriamine, triethylenetetramine, tetraethylenepentamine, monoethanolamine, diethanolamine and/or triethanolamine.

In a most preferred embodiment, component (ii) is ammonia. The ammonia may be added as an ammonium salt and/or as ammonia. Ammonia is particularly preferred as it is relatively inexpensive and easy to handle, in comparison to other amine compounds. Use of ammonia in the binder composition disclosed herein also results in a lower curing onset and endset, in comparison to use of other amines.

### Component (iii) of the Binder Composition

Component (iii) is in the form of one or more carbohydrates. Starch may be used as a raw material for various carbohydrates such as glucose syrups and dextrose. Depending on the reaction conditions employed in the hydrolysis of starch, a variety of mixtures of dextrose and intermediates are obtained which may be characterized by their DE number. DE is an abbreviation for Dextrose Equivalent and is defined as the content of reducing sugars, expressed as the number of grams of anhydrous D-glucose per 100 g of the dry matter in the sample, when determined by the method specified in International Standard ISO 5377-1981 (E). This method measures reducing end groups and attaches a DE of 100 to pure dextrose and a DE of 0 to pure starch.

In a preferred embodiment, the carbohydrate is selected from sucrose, reducing sugars, in particular dextrose, polycarbohydrates, and mixtures thereof, preferably dextrins and maltodextrins, more preferably glucose syrups, and more preferably glucose syrups with a dextrose equivalent value of DE=20-99, such as DE=50-85, such as DE=60-99. The term “dextrose” as used in this application is defined to encompass glucose and the hydrates thereof.

In a further preferred embodiment, the carbohydrate is selected from hexoses, in particular allose, altrose, glucose, mannose, gulose, idose, galactose, talose, psicose, fructose, sorbose and/or tagatose; and/or pentoses, in particular arabinose, lyxose, ribose, xylose, ribulose and/or xylulose; and/or tetroses, in particular erythrose, threose, and/or erythrulose.

In a further preferred embodiment, the carbohydrate is selected from a hexose such as fructose, and/or a pentose such as xylose.

In a particularly preferred embodiment, component (iii) is selected from dextrose, glucose syrup, xylose, fructose or sucrose. Glucose syrup is preferred as it is an inexpensive source of glucose.

Since the carbohydrates of component (iii) are comparatively inexpensive compounds and are produced from renewable resources, the inclusion of high amounts of component (iii) in the binder allows the production of a binder for MMVF which is advantageous under economic aspects and at the same time allows the production of an ecological non-toxic binder. This is of particular advantage in binders for plant growth substrates, as plants are sensitive to certain compounds, which can often negatively impact their growth and development. In the present invention, the use of starch allows for a binder composition with low phytotoxicity.

In a preferred embodiment, the proportion of components (i), (ii) and (iii) is within the range of 1 to 50 weight-% component (i) based on the mass of components (i) and (iii), 50 to 99 weight-% component (iii) based on the mass of components (i) and (iii), and 0.1 to 10.0 molar equivalents of component (ii) relative to component (i). When component (i) is present in a weight % component of greater than 50%, then the binder strength is lower than desired. The addition of an amine according to component (ii) in the above molar equivalents increases the strength of the binder composition.

In a particularly preferred embodiment of the present invention, the binder composition prior to curing comprises ascorbic acid as component (i), ammonia as component (ii) and dextrose and/or glucose with a DE of 60-99 as component (iii).

### Component (iv) of the Binder Composition

In a preferred embodiment, the binder composition according to the present invention further comprises a component (iv) in the form of one or more additives. These additives (iv) are preferably catalysts for the reaction that forms the binder on curing, namely they do not get consumed in the reaction.

Preferably the additive is a mineral acid or salts thereof. It has surprisingly been found that by adding a mineral acid to the binder composition, the properties of the binder composition according to the present invention can be strongly improved. In particular, we have found that by including a mineral acid such as hypophosphorous acid in the binder composition according to the present invention, the temperature of curing onset and curing endset can be strongly reduced. Further, the reaction loss can be reduced by including a mineral acid, while at the same time the mechanical properties of the MMVF growth substrate product are retained.

In a particularly preferred embodiment, component (iv) is selected from the group consisting of ammonium sulfate salts, ammonium phosphate salts, ammonium nitrate salts and ammonium carbonate salts. Ammonium sulfate salts may include (NH₄)₂SO₄, (NH₄)HSO₄ and (NH₄)₂Fe(SO₄)₂.6H₂O. Ammonium carbonate salts may include (NH₄)₂CO₃ and NH₄HCO₃. Ammonium phosphate salts may include H(NH₄)₂PO₄, NH₄H₂PO₄, ammonium hypophosphite and ammonium polyphosphate.

In a particularly preferred embodiment, component (iv) is selected from the group consisting of sulfuric acid, nitric acid, boric acid, hypophosphorous acid and phosphoric acid, sulfamic acid and salts thereof. Preferably component (iv) is the sodium salt of hypophosphorous acid.

Component (iv) can be selected from the group consisting of sulfamic acid and any salt thereof, such as ammonium sulfamate, calcium sulfamate, sodium sulfamate, potassium sulfamate, magnesium sulfamate, cobalt sulfamate, nickel sulfamate, N-cyclohexyl sulfamic acid and any salt thereof, such as sodium N-cyclohexyl sulfamate. In a particularly preferred embodiment, component (iv) is ammonium sulfamate.

Sulfamic acid is a non-toxic compound having the formula;

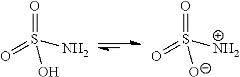 [SMILES: NS(=O)(=O)O ; [NH3+]S(=O)(=O)[O-]]

Sulfamic acid and many of its salts are storage stable non-volatile compounds and are available at a comparatively low price. This allows for production of a binder composition for use in MMVF plant growth substrates which is economical.

Besides providing binders which allow the production of mineral wool products having excellent mechanical properties, the inclusion of component (iv) also in general imparts improved fire resistance and anti-punking properties for aspects according to the MMVF plant growth substrate of the present invention. Further, the use of sulfamic acid and its derivatives in a binder composition is particularly beneficial for plant growth substrates as these compounds have low phytotoxicity.

In a particularly preferred embodiment, component (iv) is present in an amount of 0.05 to 10 weight-%, such as 1 to 7 weight-%, based on the mass of components (i), and (iii), whereby component (ii) is preferably present in the amount of 0.1 to 10 molar equivalents of component (ii) relative to the combined molar equivalents of component (i) and component (iv).

### Component (v) of the Binder Composition

Optionally, the aqueous binder composition according to the present invention further comprises a component (v) in form of urea. Preferably the urea is present in an amount of 0 to 20 weight-% urea, more preferably 0 to 10 weight-% urea, based on the mass of components (i), and (iii).

Urea is preferably present in the binder composition of the present invention for prevention of punking.

### Wetting Agent

The coherent growth substrate of the present invention comprises a wetting agent. A wetting agent will increase the amount of water that the growth substrate product can absorb. The use of a wetting agent in combination with a hydrophobic binder results in a hydrophilic growth substrate product.

The wetting agent may be any of the wetting agents known for use in MMVF substrates that are used as growth substrates.

The wetting agent may be a non-ionic wetting agent such as Triton X-100 or Rewopal. Rewopal is an oleic acid polyethoxylate wherein the number of ethoxy groups n=70. Some non-ionic wetting agents may be washed out of the MMVF substrate over time. It may therefore be preferable to use an ionic wetting agent, especially an anionic wetting agent, such as linear alkyl benzene sulphonate (LAS). These do not wash out of the MMVF substrate to the same extent. A preferred example is the sodium salt of linear alkyl benzene sulfonate.

In a preferred embodiment, the wetting agent is an alkyl ether sulphate surfactant. The wetting agent may be an alkali metal alkyl ether sulphate or an ammonium alkyl ether sulphate. Preferably the wetting agent is a sodium alkyl ether sulphate.

Preferably the alkyl in the alkyl ether sulphate has a chain length of 8 to 18 carbons, preferably 12 to 15 carbons, preferably 12 to 14 carbons. Such alkyl ether sulphates have a preferred molecular size which means that they are less likely to be washed out of the growth substrate product.

Preferably the wetting agent has an average degree of ethoxylation in the range 1 to 5, more preferably in the range 2 to 4. Use of such alkyl ether sulphates in growth substrate products allows the products to show enhanced wetting properties. This is believed to be due to the larger surface-tension-lowering effect of such alkyl ether sulphates, which results in lower contact angles and therefore efficient and uniform spreading of water over the fibre surface (relative to more highly ethoxylated alkyl ether sulphates).

Preferably the wetting agent has the formula

RO(CH₂CH₂O)ₙSO₃Na

wherein R is a C8-18 linear or branched, cyclic or non-cyclic alkyl group, preferably wherein R is a C12-15 linear or branched, cyclic or non-cyclic alkyl group, more preferably wherein R is a C12-14 linear or branched, cyclic or non-cyclic alkyl group; and wherein n is in the range 1 to 10, preferably wherein n is in the range 2 to 3. Such wetting agents display a large surface tension lowering effect, which results in low contact angles and therefore efficient and uniform spreading of water over the fibre surface.

A particularly preferred wetting agent is sodium lauryl ether sulphate (SLES), preferably wherein the wetting agent has an average degree of ethoxylation in the range 2 to 3. Such average degrees of ethoxylation are preferred as this equates to a low surface tension of sodium lauryl ether sulphate, which results in large surface-tension-lowering effect and therefore efficient and uniform spreading of water over the fibre surface.

Levels of wetting agent are preferably in the range 0.05 to 3 wt %, based on the weight of the growth substrate product, in particular in the range 0.05 to 0.8 wt %, based on the weight of the growth substrate product.

Particular advantages of an alkyl ether sulphate wetting agent are that it is not easily washed out of growth substrate products. Alkyl ether sulphates improve the initial wetting of the growth substrate product compared to known wetting agents. Growth substrate products using the wetting agent of the invention are stable and maintain their initial wetting and resaturation properties in use over time.

Alkyl ether sulphates are particularly preferred as they are low toxicity wetting agents that do not adversely affect plant growth, compared to more commonly used wetting agents such as LAS. Furthermore, alkyl ether sulphates can be applied in the manufacture of a growth substrate product without the need for an additional processing agent, unlike wetting agents such as LAS.

The present inventors found that when wetting agents as defined above, including LAS and alkyl ether sulphates, are used in combination with the binder composition of the present invention, excellent water-handling properties are seen. For example, the present invention shows improved re-saturation properties; improved water distribution properties; improved water retention and improved initial wetting. This ultimately leads to the growth of stronger and healthier plants.

Furthermore, when a wetting agent is used in combination with the binder composition of the present invention, improved seed retention and propagation, rooting-in and plant growth with a higher proportion of plants in the required selection category and with the highest uniformity between the plants is seen.

Furthermore, when a wetting agent is used in combination with the binder composition of the present invention, reduced foam formation is seen. Foaming is an undesirable side effect which can result when growth substrates are subjected to wetting in a wetting line in which a spray of water droplets is applied to the substrate. Excess water and water which passes through the product is collected and recycled to the spraying system.

The growth substrate product may contain other types of conventional additives in addition to binder and wetting agents, for instance salts such as ammonium sulphate and adhesion promoters such as silanes.

### Use of the Growth Substrate Product

The present invention provides the use of a growth substrate product as a growth substrate for growing plants, or for propagating seeds. It is intended that the growth substrate product of the invention is used for growing plants and for propagating seeds.

### Method of Growing Plants

The present invention provides a method of growing plants in a coherent growth substrate product, the method comprising:

providing at least one growth substrate product formed of man-made vitreous fibres bonded with a cured binder composition and a wetting agent;

positioning one or more plants for growth in the growth substrate product; and

irrigating the growth substrate product;

characterised in that the binder composition prior to curing is as described above in the present invention.

Irrigation may occur by direct irrigation of the growth substrate product, that is, water is supplied directly to the growth substrate product, such as by a wetting line, tidal flooding, a dripper, sprinkler or other irrigation system.

The growth substrate product used in the method of growing plants is preferably as described above.

### Method of Propagating Seeds

The present invention provides a method of propagating seeds in a coherent growth substrate product, the method comprising:

providing at least one growth substrate product formed of man-made vitreous fibres bonded with a cured binder composition and a wetting agent,

positioning one or more seeds in the growth substrate product,

irrigating the growth substrate product; and

allowing germination and growth of the seed to form a seedling;

characterised in that the binder composition prior to curing is as described above in the present invention.

Irrigation may occur by direct irrigation of the growth substrate product, that is, water is supplied directly to the growth substrate product, such as by a wetting line, tidal flooding, a dripper, sprinkler or other irrigation system.

The growth substrate product used in the method of propagating seeds is preferably as described above.

### Process of Making a Coherent Growth Substrate

A process of making a coherent growth substrate product comprising the steps of:

i. providing man-made vitreous fibres;

ii. spraying the man-made vitreous fibres with a binder composition;

iii. spraying the man-made vitreous fibres with a wetting agent;

iv. collecting and consolidating the man-made vitreous fibres; and

v. curing the binder composition;

characterised in that the binder composition prior to curing is as described above in the present invention.

Preferably, steps ii and iii occur substantially simultaneously. This means that the binder composition and the wetting agent may be sprayed from separate spraying devices. Alternatively, the wetting agent and the binder may be mixed and sprayed from the same spraying device. An advantage of the binder and the wetting agent being sprayed substantially simultaneously is that the man-made vitreous fibres receive a consistent amount of both the binder and the wetting agent.

### EXAMPLES

The invention will now be described in relation to the following non-limiting examples.

### Example 1

The synthesis of binders according to the present invention and known binder compositions was carried out as follows;

### Binder A (Reference Binder)

A phenol-formaldehyde resin modified with urea, a PUF-resol, was prepared. This binder is similar to known formaldehyde binder compositions from the prior art. A phenol-formaldehyde resin was prepared by reacting 37% aq. formaldehyde (606 g) and phenol (189 g) in the presence of 46% aq. potassium hydroxide (25.5 g) at a reaction temperature of 84° C. preceded by a heating rate of approximately 1° C. per minute. The reaction was continued at 84° C. until the acid tolerance of the resin was 4 and most of the phenol was converted. The test for acid tolerance is described in more detail below. Urea (241 g) was then added and the mixture was cooled.

Using the urea-modified phenol-formaldehyde resin obtained, a binder was made by addition of 25% aq. ammonia (90 mL) and ammonium sulfate (13.2 g) followed by water (1.30 kg).

For binder mixes containing a wetting agent, the required amount of wetting agent was then added (for example, Rewopal, SLES, LAS).

A final binder mixture with a desired binder solids was then produced by diluting with the required amount of water and 10% aq. silane (15% binder solids solution; 0.5% silane of binder solids).

### Binder B (Reference Binder)

A binder was prepared based on alkanolamine-polycarboxylic acid anhydride reaction products. This binder is in accordance with the binder composition disclosed in WO2012/028650.

Diethanolamine (DEA, 231.4 g) was placed in a 5-litre glass reactor provided with a stirrer and a heating/cooling jacket. The temperature of the diethanolamine was raised to 60° C. where after tetrahydrophthalic anhydride (THPA, 128.9 g) was added. After raising the temperature and keeping it at 130° C., a second portion of tetrahydrophthalic anhydride (64.5 g) was added followed by trimellitic anhydride (TMA, 128.9 g). After reacting at 130° C. for 1 hour, the mixture was cooled to 95° C. Water (190.8 g) was added and stirring was continued for 1 hour. After cooling to ambient temperature, the mixture was poured into water (3.40 kg) and 50% aq. hypophosphorous acid (9.6 g) and 25% aq. ammonia (107.9 g) were added under stirring. Glucose syrup (1.11 kg) was heated to 60° C. and then added under stirring followed by 50% aq. silane (5.0 g, Momentive VS-142).

For binder mixes containing a wetting agent, the required amount of wetting agent was then added (for example, Rewopal, SLES, LAS).

A final binder mixture with a desired binder solids was then produced by diluting with the required amount of water (15% binder solids solution).

### Binder C (Binder According to the Invention)

A binder composition for use in the present invention was prepared. A mixture of L-ascorbic acid (3.00 g, 17.0 mmol) and 75.1% aq. glucose syrup (36.0 g; thus efficiently 27.0 g glucose syrup) in water (61.0 g) was stirred at room temperature until a clear solution was obtained. 50% aq. hypophosphorous acid (1.20 g; thus 0.60 g, 9.10 mmol hypophosphorous acid) was then added. 28% aq. ammonia (1.86 g; thus 0.52 g, 30.6 mmol ammonia) was then added dropwise until pH=6.6.

The wetting agent can be incorporated into Binder C as follows. 27% aq. SLES (0.041 g/g binder mixture) was added at the end of the above procedure, and the mixture was stirred until homogeneous.

For DMA and water absorption studies (15% binder solids solution, 0.5% silane of binder solids), the binder mixture was diluted with water (0.354 g/g binder mixture) and 10% aq. silane (0.010 g/g binder mixture). The final binder mixture had pH=6.7.

### Binder D (Binder According to the Invention)

A binder composition for use in the present invention was prepared. A mixture of L-ascorbic acid (3.00 g, 17.0 mmol) and 75.1% aq. glucose syrup (36.0 g; thus 27.0 g glucose syrup) in water (61.0 g) was stirred at room temperature until a clear solution was obtained. 50% aq. hypophosphorous acid (1.20 g; thus 0.60 g, 9.10 mmol hypophosphorous acid) and urea (1.50 g) was then added. 28% aq. ammonia (1.83 g; thus 0.51 g, 30.1 mmol ammonia) was then added dropwise until pH=7.0.

The wetting agent can be incorporated into Binder D as follows. 27% aq. SLES (0.042 g/g binder mixture) was added at the end of the above procedure and the mixture was stirred until homogeneous.

For DMA and water absorption studies (15% binder solids solution, 0.5% silane of binder solids), the binder mixture was diluted with water (0.391 g/g binder mixture) and 10% aq. silane (0.011 g/g binder mixture). The final binder mixture had pH=7.0.

### Binder E (Binder According to the Invention)

A mixture of L-ascorbic acid (6.26 g, 35.5 mmol) and 75.1% aq. glucose syrup (33.4 g; thus 25.1 g glucose syrup) in water (57.1 g) was stirred at room temperature. 28% aq. ammonia (3.13 g; thus 0.88 g, 51.5 mmol ammonia) was then added dropwise until pH=8.8.

The wetting agent can be incorporated into Binder E as follows. 27% aq. SLES (0.040 g/g binder mixture) was added at the end of the above procedure, the mixture was stirred until homogeneous.

For DMA and water absorption studies (15% binder solids solution, 0.5% silane of binder solids), the binder mixture was diluted with water (0.335 g/g binder mixture) and 10% aq. silane (0.010 g/g binder mixture). The final binder mixture had pH=8.8.

### Example 2

Various properties of the above described binder compositions were investigated, including curing onset, curing endset, reaction loss and water absorption. The results are shown in Tables 1 and 2 below. In Table 1, Reference Binders A1-A4 were prepared as described above for Binder A, and Reference Binders B1-B4 were prepared as described for Binder B. In Table 2, New Binders C1-C4, D1-D4 and E1-E4 were prepared as described above for Binder C, Binder D and Binder E, respectively.

TABLE 1
Reference Binders

| | Reference binders | | | | Reference binders | | | |
|---|---|---|---|---|---|---|---|---|
| Example | A1 | A2 | A3 | A4 | B1 | B2 | B3 | B4 |
| Wetting agent (%-wt. added) ^{[a]} | | | | | | | | |
| Rewopal | — | 10.0 | — | — | — | 10.0 | — | — |
| LAS | — | — | 4.8 | — | — | — | 4.8 | — |
| SLES | — | — | — | 5.4 | — | — | — | 5.4 |
| Silane (% of binder solids) ^{[b]} | 0.5 | 0.5 | 0.5 | 0.5 | — | — | — | — |
| Binder properties | | | | | | | | |
| Curing onset (° C.) | 150 | 150 | 158 | 156 | 180 | 177 | 182 | 185 |
| Curing endset (° C.) | 171 | 171 | 175 | 173 | 210 | 211 | 216 | 218 |
| Reaction loss (%) | 29 | 32 | 32 | 34 | 29 | 32 | 32 | 32 |
| pH of 15% soln. | 9.6 | 96 | 9.6 | 9.5 | 5.8 | 5.9 | 5.9 | 5.9 |
| Water absorption properties | | | | | | | | |
| Water absorption, 30 sec vertical (%) | 2 | 4 | 29 | 23 | 22 | 2 | 36 | 38 |
| Water absorption, 1 min submerged (%) | 7 | 13 | 37 | 48 | 31 | 5 | 50 | 50 |
| Water absorption, 24 h submerged (%) | 28 | 36 | 38 | 50 | 33 | 18 | 51 | 52 |

^{[a]} Of binder solids.
^{[b]} Silane (Momentive VS-142) was supplied by Momentive and was calculated as 100% for simplicity.

TABLE 2
Binders according to the invention

| | Example | | | | | | | | | | | |
|---|---|---|---|---|---|---|---|---|---|---|---|---|
| | C1 | C2 | C3 | C4 | D1 | D2 | D3 | D4 | E1 | E2 | E3 | E4 |
| Binder composition | | | | | | | | | | | | |
| Component (i) | | | | | | | | | | | | |
| L-Ascorbic acid (%-wt) | 10 | 10 | 10 | 10 | 10 | 10 | 10 | 10 | 20 | 20 | 20 | 20 |
| Component (iii) | | | | | | | | | | | | |
| Glucose syrup (%-wt) | 90 | 90 | 90 | 90 | 90 | 90 | 90 | 90 | 80 | 80 | 80 | 80 |
| Component (iv) ^{[a]} | | | | | | | | | | | | |
| Hypophosphorous acid (%-wt) | 2 | 2 | 2 | 2 | 2 | 2 | 2 | 2 | — | — | — | — |
| Component (v) Urea ^{[a]} | — | — | — | — | 5 | 5 | 5 | 5 | — | — | — | — |
| Component (ii)(equiv.) ^{[b]} | | | | | | | | | | | | |
| Ammonia | 1.2 | 1.2 | 1.2 | 1.2 | 1.2 | 1.2 | 1.2 | 1.2 | 1.4 | 1.4 | 1.4 | 1.4 |
| Wetting agent (%-wt. added) ^{[c]} | | | | | | | | | | | | |
| Rewopal | — | 10.0 | — | — | — | 10.0 | — | — | — | 10.0 | — | — |
| LAS | — | — | 4.8 | — | — | — | 4.8 | — | — | — | 4.8 | — |
| SLES | — | — | — | 5.4 | — | — | — | 5.4 | — | — | — | 5.4 |
| Silane (% of binder solids) ^{[d]} | 0.5 | 0.5 | 0.5 | 0.5 | 0.5 | 0.5 | 0.5 | 0.5 | 0.5 | 0.5 | 0.5 | 0.5 |
| Binder properties | | | | | | | | | | | | |
| Curing onset (° C.) | 172 | 173 | 173 | 173 | 170 | 172 | 170 | 170 | 175 | 182 | 174 | 178 |
| Curing endset (° C.) | 191 | 193 | 194 | 192 | 192 | 194 | 195 | 192 | 198 | 201 | 199 | 199 |
| Reaction loss (%) | 32 | 34 | 32 | 31 | 33 | 33 | 31 | 31 | 37 | 39 | 38 | 37 |
| pH of 15% soln. | 6.2 | 6.7 | 6.8 | 6.8 | 7.0 | 7.0 | 7.1 | 7.0 | 8.8 | 8.8 | 8.8 | 8.8 |
| Water absorption properties | | | | | | | | | | | | |
| 30 sec vertical (%) | 23 | 1 | 39 | 43 | 9 | 1 | 34 | 36 | 9 | 2 | 30 | 39 |
| 1 min submerged (%) | 29 | 4 | 45 | 49 | 24 | 5 | 35 | 40 | 23 | 8 | 40 | 42 |
| 24 h submerged (%) | 31 | 25 | 46 | 50 | 35 | 18 | 37 | 42 | 32 | 14 | 43 | 43 |

^{[a]} Of component (i) + component (iii).
^{[b]} Molar equivalents relative to component (i) + component (iv).
^{[c]} Of binder solids.
^{[d]} Silane (Momentive VS-142) was supplied by Momentive and was calculated as 100% for simplicity.

### Binder solids

The content of a binder after curing is termed “binder solids”. It is measured as follows.

Disc-shaped stone wool samples (diameter: 5 cm; height 1 cm) were cut out of stone wool and heat-treated at 580° C. for at least 30 minutes to remove all organics. The solids of the binder mixture was measured by distributing a sample of the binder mixture (lumini. 2 g) onto a heat treated stone wool disc in a tin foil container. The weight of the tin foil container containing the stone wool disc was weighed before and directly after addition of the binder mixture. Two such binder mixture loaded stone wool discs in tin foil containers were produced and they were then heated at 200° C. for 1 hour. After cooling and storing at room temperature for 10 minutes, the samples were weighed and the binder solids was calculated as an average of the two results.

### Binder Component Solids Content

The content of each of the components in a given binder solution before curing is based on the anhydrous mass of the components.

### Reaction Loss

The reaction loss is defined as the difference between the binder component solids content and the binder solids.

### Curing Onset and Endset

The method of determining the curing onset and endset involves DMA (dynamic mechanical analysis) measurements.

A 15% binder solids binder solution was obtained by dilution of the above described binder compositions A to E with the required amount of water. Cut and weighed glass Whatman™ glass microfiber filters (GF/B, 150 mm Ø, cat. No. 1821 150) (2.5×1 cm) were submerged into the 15% binder solution for 10 seconds. The resulting binder-soaked filter was then dried in a “sandwich” consisting of (1) a 0.60 kg 8×8×1 cm metal plate, (2) four layers of standard filter papers, (3) the binder soaked glass microfiber filter, (4) four layers of standard filter papers, and (5) a 0.60 kg 8×8×1 cm metal plate for approximately 2×2 minutes by applying a weight of 3.21 kg on top of the “sandwich”. In a typical experiment, the cut Whatman™ glass microfiber filter would weigh 0.035 g before application of the binder and 0.125 g after application and drying which corresponds to a binder solution loading of 72%. All DMA measurements were performed with 72±1% binder solution loadings.

The DMA measurements were acquired on a Mettler Toledo DMA 1 calibrated against a certified thermometer at ambient temperature and the melting points of certified indium and tin. The apparatus was operated in single cantilever bending mode; titanium clamps; clamp distance 1.0 cm; temperature segment type; temperature range 40-280° C.; heating rate 3° C./min; displacement 20 μm; frequency 1 Hz; single frequency oscillation mode. Curing onset and endset were evaluated using STARe software Version 12.00.

### Water Absorption Studies

The water absorption characteristics of the binders were studied in a tablet test. For each binder, two tablets were manufactured from a mixture of the binder and stone wool shots from the stone wool spinning production.

For each of the binder compositions A to E, a 15% binder solids solution containing the required amounts of silane (Momentive VS-142) was obtained. A sample of this binder solution (4.0 g) was mixed well with shots (20.0 g). Shots are particles which have the same melt composition as the stone wool fibers, and the shots are normally considered a waste product from the spinning process. The shots used for the tablet composition have a size of 0.25-0.50 mm.

The resulting mixture was then transferred into a round aluminium foil container (bottom Ø=4.5 cm, top Ø=7.5 cm, height=1.5 cm). The mixture was then pressed hard with a suitably sized flat bottom glass or plastic beaker to generate an even tablet surface. Two tablets from each binder were made in this fashion. The resulting tablets were then dried at 95° C. for 1 h followed by curing at 250° C. for 1 h. After cooling to room temperature, the tablets were carefully taken out of the containers.

The tablets were weighed and were then dipped vertically into 2 cm deep water in a 250 mL glass beaker with inner Ø=5.5 cm for 30 seconds, lifted up vertically and held in this position until there was >10 seconds between each drop, followed by weighing. The tablets were then completely submerged horizontally in water for 1 minute, lifted up and held horizontally until there was >10 seconds between each drop and then turned gently vertical and held in this position until there was >10 seconds between each drop. The tablets were then weighed. Finally, the tablets were left submerged horizontally in water for 24 h at room temperature followed by the same dripping off procedure as above and then weighing.

### Conclusions

From Tables 1 and 2, the following conclusion can be drawn;

The inclusion of wetting agents has only a minor (if any) impact on the curing characteristics. This can be seen, for example, with comparison of the curing onset and endset of C1 with C2/C3/C4 in Table 2. This is advantageous as a negative impact would have been a drawback.

Similarly, the reaction losses also remain unchanged upon addition of a wetting agent; a significant increase would have been undesirable.

The water absorption data clearly demonstrates that the addition of SLES or LAS to the new binders does increase the water absorption compared to the wetting-agent-free binders.

From comparison of the curing onset and endset temperatures between reference binders and new binders, it can be seen that the binders used in the present invention have curing conditions which are comparable to Binder A formaldehyde binders and lower than known formaldehyde-free binders, Binder B.

From comparison of the water absorption properties between reference binders and new binders, it can be seen that water absorption is improved for binders of the present invention when SLES is used.

### Example 3

A plant phytotoxicity test was undertaken in order to investigate the effect of binders as defined according to the present invention on plant growth (Binders C, D and E). Known binders, phenol urea formaldehyde (Binder A) and the sugar-based binder composition as defined in WO2012/028650 (Binder B) were also investigated for comparison.

All binders were diluted to 3-4 solutions with nutrient solution, having the following concentrations;

| | |
|---|---|
| A | 0.04%, 0.4%, 4%, 6% |
| B | 0.04%, 0.4%, 4% |
| C | 0.04%, 0.4%, 4%, 6% |
| D | 0.04%, 0.4%, 4%, 6% |
| E | 0.04%, 0.4%, 4%, 6% |

Virgin stone wool was submerged with 160 ml of a solution, 3 seeds were planted and covered with vermiculite per pot. The pots were then transferred to a growing chamber for a week. Afterwards the length of the first leaf (cotyledon leaf) and the total amount of germination per pot (1, 2 or 3 seeds germinated) were measured. Flamingo seeds (cucumber) were used.

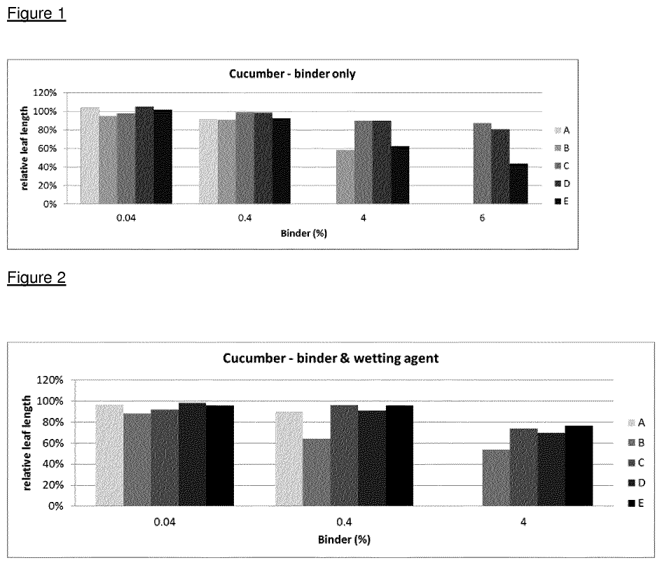

The bar chart in FIG. 1 shows the leaf length per concentration and per binder.

It can be seen from the FIG. 1 that the binders of the present invention generally have a better influence on the growth of the plant in relation to the current binders. When Reference Binder A is used at high concentrations of 4/6%, no growth is observed.

The above test was repeated on cucumber seeds, but this time including a sodium alkyl ether sulphate as a wetting agent (SLES). The binders in combination with the SLES wetting agent had the following concentrations (with a ratio of 1 SLES: 40 binder)

| | | | |
|---|---|---|---|
| Binder | 0.04% | 0.4% | 4% |
| Wetting agent (SLES) | 0.001% | 0.01% | 0.1% |

The results are shown in FIG. 2. It can be seen from the FIG. 2 that the binders of the present invention show better growth in relation to Binders A and B. When Reference Binder A is used at high concentrations of 4%, no growth is observed.

### Example 4

Multiple properties of MMVF growth substrates according to the present invention were investigated and compared with the properties of known growth substrates. The growth substrates according to the present invention, referred to as ‘New Plug’, ‘New Block’ and ‘New Slab’ contained a binder composition as described herein (Binder D) and SLES as a wetting agent. ‘Reference Plug’ contained a phenol formaldehyde binder (Binder A) and Rewopal wetting agent, ‘Reference Block’ and ‘Reference Slab’ contained a phenol formaldehyde binder (Binder A) and an LAS wetting agent. The plugs, block and slabs have dimensions and volumes in accordance with the ranges described herein. The results of the testing of plant tolerance, formaldehyde leaching, water retention, re-saturation, water distribution over height and initial wetting are shown in the table below.

TABLE 3

| | New Plug vs. | New Block vs. | NewSlab vs |
|---|---|---|---|
| Property | Reference plug | Reference block | Reference slab |
| Plant tolerance | Improved (+6%) | Improved (+6%) | Improved (+5%) |
| Formaldehyde | Improved | Improved | Improved |
| leaching | (−5 mg/l) | (−8 mg/l) | (−5 mg/l) |
| Water retention | Increased | Increased (+17%) | Increased (+5%) |
| (WC-10) | (+30%) | | |
| Re-saturation | Increased | Increased (+7%) | Increased (+2%) |
| | (+8%) | | |
| Water | Improved | Comparable | Comparable |
| distribution | | | |
| over the height | | | |
| Initial wetting | Comparable | Improved | Improved |

### Plant Tolerance

Samples were prepared by impregnating the test specimen with a nutrient solution. After 16 hours samples were squeezed out and filtered to produce a leachate.

This leachate was added to virgin stonewool granulate and cucumber plants were grown in a climate chamber for one week. The relative lobe length was measured and the results are shown in the first row of Table 2. The results show that improved plant tolerance is seen in comparison to known binder/wetting agent systems.

### Formaldehyde Leaching

A buffer solution was added to the test specimen and stored for 16 hours at 35° C. The solution is filtered and a UV-sensitive colourant is added. The samples are then analysed with HPLC-UV detection. Plants are sensitive to high concentrations of formaldehyde, which is known to have a negative effect on plant growth and development. As can be seen from the results above, the amount of formaldehyde in the present binder/wetting agent composition is considerably lower than the amount in known binder/wetting agent combinations.

### Water Retention

Plugs, blocks and slabs as described above were rinsed three times with water. Afterwards, the water retention level was measured as described in EP-A-310501. In principle, the samples are saturated with water and are then put on a sand bed. Using as a reference the middle of the sample, the sample is then put via the sand bed on an underpressure of 10 cm water column. After 4 hours, the sample is taken from the sand bed and weighed. On basis of the measured dry and wet weight and the measured dimensions of the samples, the water content on volume basis is calculated.

Again, the results in Table 2 clearly show that the binder/wetting agent system of the present invention has improved water retention in comparison to known binder/wetting agent systems.

### Re-Saturation

Re-saturation is defined as the ability of a growth substrate to take up water a second time once it has been wetted and then dried. Samples were saturated with water and then drained until the samples had a total water content of 50% ±2%. Then the samples were placed in a container in which the height of the water is 5 mm. After 4 hours the samples were taken out of the container and weighed. The weight after 4 hours was measured and this result together with the dimensions of the sample gives a water content on volume basis after 4 hours. This is then a measure for the re-saturation capacity.

The results are shown in Table 2, and clearly demonstrate that re-saturation for growth substrates of the present invention is improved when viewed in relation to binder/wetting agent combinations from the prior art.

### Water Distribution Over the Height

Water distribution over the height is defined as the ability of a growth substrate to hold water at a more uniform concentration throughout the height of the growth substrate rather than concentrating at the base

The samples were saturated with water and then drained until the samples had a total water content of 50% ±2%. Then the water content was measured at different heights of the samples with a water content meter.

The results are shown in table 2; it can be concluded that no significant differences are seen for the slabs and blocks (which are only 6.5 cm in height). For plugs a clear difference is noticed with the samples from the prior art; the plugs of the present invention have improved water distribution over height.

### Initial Wetting

The samples were weighed dry and their dimensions in dry form were also measured. The samples were sprayed with water by placing them on a wetting line and letting the samples absorb the water. After passing all spraying beams the samples with the water were weighed. Based upon the measured weight dry and the measured dimensions of the samples, the initial wetting is calculated on a volume basis.

For blocks and slabs of the present invention, the initial wetting is clearly improved in relation to prior art products. The results for plugs are comparable.

### Acid Tolerance

The acid tolerance (AT) expresses the number of times a given volume of a binder can be diluted with acid without the mixture becoming cloudy (the binder precipitates). Sulfuric acid is used to determine the stop criterion in a binder production and an acid tolerance lower than 4 indicates the end of the binder reaction.

To measure the AT, a titrant is produced from diluting 2.5 ml conc. sulfuric acid (>99%) with 1 L ion exchanged water. 5 mL of the binder to be investigated is then titrated at room temperature with this titrant while keeping the binder in motion by manually shaking it; if preferred, a magnetic stirrer and a magnetic stick can be used. Titration is continued until a slight cloud appears in the binder, which does not disappear when the binder is shaken.

The acid tolerance (AT) is calculated by dividing the amount of acid used for the titration (mL) with the amount of sample (mL):

AT=(Used titration volume (mL))/(Sample volume (mL))

1. A coherent growth substrate product formed of man-made vitreous fibres (MMVF) bonded with a cured binder composition and a wetting agent, wherein the binder composition prior to curing comprises the following components:
a component (i) in the form of one or more compounds selected from
compounds of the formula, and any salts thereof: 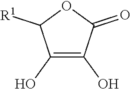
in which R1 corresponds to H, alkyl, monohydroxyalkyl, dihydroxyalkyl, polyhydroxyalkyl, alkylene, alkoxy, amine;
compounds of the formula, and any salts thereof: 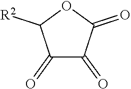
in which R2 corresponds to H, alkyl, monohydroxyalkyl, dihydroxyalkyl, polyhydroxyalkyl, alkylene, alkoxy, amine;
a component (ii) in the form of one or more compounds selected from the group of
ammonia, amines or any salts thereof;
a component (iii) in the form of one or more carbohydrates.

2. The growth substrate product according to claim 1 wherein the wetting agent is an alkyl ether sulphate.

3. The growth substrate product according to claim 1 wherein the wetting agent is an alkali metal alkyl ether sulphate or an ammonium alkyl ether sulphate.

4. The growth substrate product according to claim 1, wherein the wetting agent is a sodium alkyl ether sulphate.

5. The growth substrate product according to claim 1, wherein the wetting agent is sodium lauryl ether sulphate.

6. The growth substrate product according to claim 1, wherein the binder composition is an aqueous binder composition.

7. The growth substrate product according to claim 1, wherein the component (i) is selected from the group of L-ascorbic acid, D-isoascorbic acid, 5,6-isopropylidene ascorbic acid, dehydroascorbic acid and/or any salt of the compounds, preferably calcium, sodium, potassium, magnesium or iron salts.

8. The growth substrate product according to claim 1, wherein the component (ii) is in the form of one or more amines selected from the group of ammonia, piperazine, hexadimethylenediamine, m-xylylenediamine, diethylenetriamine, triethylenetetramine, tetraethylenepentamine, monoethanolamine, diethanolamine and/or triethanolamine.

9. The growth substrate product according to claim 1, wherein the component (iii) is in the form of one or more carbohydrates selected from the group of dextrose, glucose syrup, xylose, fructose or sucrose.

10. The growth substrate product according to claim 1, wherein the binder composition prior to curing comprises;
component (i) in the form of ascorbic acid;
component (ii) in the form of ammonia;
component (iii) in the form of dextrose and/or a glucose syrup with a DE of 60-99.

11. The growth substrate product according to claim 1, wherein the proportion of components (i), (ii) and (iii) is within the range of 1 to 50 weight-% component (i) based on the mass of components (i) and (iii), 50 to 99 weight-% component (iii) based on the mass of components (i) and (iii), and 0.1 to 10.0 molar equivalents of component (ii) relative to component (i), preferably 0.1 to 5.0 molar equivalents of component (ii) relative to component (i).

12. The growth substrate product according to claim 1, wherein the binder composition prior to curing further comprises a component (iv) in the form of one or more additives, preferably of catalytic usage.

13. The growth substrate product according to claim 12, wherein the component (iv) is a mineral acid or salts thereof.

14. The growth substrate product according to claim 13, wherein component (iv) is selected from the group of sulfuric acid, nitric acid, boric acid, hypophosphorous acid, phosphoric acid, sulfamic acid or any salt thereof.

15. The growth substrate product according to claim 14 wherein the component (iv) is present in an amount of 0.05 to 10 weight-%, such as 1 to 7 weight-%, based on the mass of components (i) and (iii), whereby component (ii) is preferably present in the amount of 0.1 to 10 molar equivalents of component (ii) relative to the combined molar equivalents of component (i) and (iv).

16. The growth substrate product according to claim 12, wherein component (iv) is selected from the group of ammonium sulfate salts, ammonium phosphate salts, ammonium nitrate salts, sodium hypophosphite, ammonium hypophosphite, ammonium sulfamate and ammonium carbonate salts.

17. The growth substrate product according to claim 1, wherein the binder composition prior to curing further comprises a component (v) in form of urea, preferably in an amount of 0 to 20 weight-% urea, preferably in an amount of 0 to 10 weight % urea based on the mass of components (i), and (iii).

18. The growth substrate product according to claim 1, wherein the growth substrate product is a plug having a volume in the range of 0.6 cm³ to 40 cm³.

19. The growth substrate product according to claim 1, wherein the growth substrate product is a block having a volume in the range of 50 cm³ to 5000 cm³, preferably 100 cm³ to 350 cm³, most preferably 250 cm³ to 2500 cm³.

20. The growth substrate product according to claim 1, wherein the growth substrate product is a slab having a volume in the range of 3 litres to 20 litres, preferably 4 litres to 15 litres, most preferably 6 litres to 15 litres.

21. The growth substrate product according to claim 1, wherein the amount of wetting agent is in the range 0.05 to 3 wt % based on the weight of the growth substrate product, preferably in the range 0.05 to 0.8 wt % based on the weight of the growth substrate product.

22. The growth substrate product according to claim 1, wherein the growth substrate product has an average density of from 30 to 150 kg/m³, preferably 30 to 100 kg/m³, more preferably 40 to 90 kg/m³.

23. (canceled)

24. A method of growing plants or propagating seeds in a coherent growth substrate product, the method comprising:
providing at least one growth substrate product formed of man-made vitreous fibres bonded with a cured binder composition and a wetting agent;
(a) positioning one or more plants for growth in the growth substrate product; and irrigating the growth substrate product; or
(b) positioning one or more seeds in the growth substrate product; and irrigating the growth substrate product to allow germination and growth of the seed to form a seedling;
characterised in that the binder composition prior to curing comprises the following components:
a component (i) in the form of one or more compounds selected from
compounds of the formula, and any salts thereof: 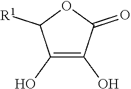
in which R1 corresponds to H, alkyl, monohydroxyalkyl, dihydroxyalkyl, polyhydroxyalkyl, alkylene, alkoxy, amine;
compounds of the formula, and any salts thereof: 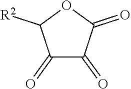
in which R2 corresponds to H, alkyl, monohydroxyalkyl, dihydroxyalkyl, polyhydroxyalkyl, alkylene, alkoxy, amine;
a component (ii) in the form of one or more compounds selected from the group of ammonia, amines or any salts thereof;
a component (iii) in the form of one or more carbohydrates.

25. (canceled)

26. (canceled)

27. (canceled)

28. A process of making a coherent growth substrate product comprising the steps of:
(i) providing man-made vitreous fibres;
(ii) spraying the man-made vitreous fibres with a binder composition;
(iii) spraying the man-made vitreous fibres with a wetting agent;
(iv) collecting and consolidating the man-made vitreous fibres; and
(v) curing the binder composition;
characterised in that the binder composition prior to curing comprises the following components:
a component (i) in the form of one or more compounds selected from
compounds of the formula, and any salts thereof: 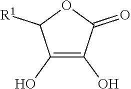
in which R1 corresponds to H, alkyl, monohydroxyalkyl, dihydroxyalkyl, polyhydroxyalkyl, alkylene, alkoxy, amine;
compounds of the formula, and any salts thereof: 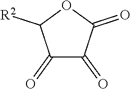
in which R2 corresponds to H, alkyl, monohydroxyalkyl, dihydroxyalkyl, polyhydroxyalkyl, alkylene, alkoxy, amine;
a component (ii) in the form of one or more compounds selected from the group of ammonia, amines or any salts thereof;
a component (iii) in the form of one or more carbohydrates.

29. A process according to claim 28, wherein steps ii and iii occur substantially simultaneously.

30. (canceled)
